(19) United States
(12) Patent Application Publication
(10) Pub. No.: US 2025/0175905 A1
(43) Pub. Date: May 29, 2025

(54) SYSTEM AND METHOD FOR UPLINK POWER CONTROL FOR A-IOT

(71) Applicant: MEDIA TEK INC., Hsinchu (TW)

(72) Inventors: Chien-Chun CHENG, Hsinchu (TW); Chiao-Yao Chuang, Hsinchu (TW); Wei-De Wu, Hsinchu (TW); Chiou-Wei Tsai, Hsinchu (TW); Tai-Cheng Tsai, Hsinchu (TW)

(21) Appl. No.: 18/954,617

(22) Filed: Nov. 21, 2024

Related U.S. Application Data
(60) Provisional application No. 63/602,691, filed on Nov. 27, 2023.

(51) Int. Cl. H04W 52/14; H04L 5/00; H04L 67/12

(52) U.S. Cl. CPC H04W 52/146; H04L 5/0055; H04L 67/12

(57) ABSTRACT

In an aspect of the disclosure, a method, a computer-readable medium, and an apparatus are provided. The apparatus may be a reader device. The reader device transmits an incident signal to an ambient internet of things (A-IoT) device. The reader device receives a response from the A-IoT device. The reader device adjusts a power of the incident signal based on a status of the response such that the power of the incident signal is at a level sufficient for communication with the A-IoT device while controlling interference with other devices.

### CROSS-REFERENCE TO RELATED APPLICATION(S)

This application claims the benefits of U.S. Provisional Application Ser. No. 63/602,691, entitled “System and Method for Uplink Power Control for A-IoT” and filed on Nov. 27, 2023, which is expressly incorporated by reference herein in its entirety.

### BACKGROUND

### Field

The present disclosure is generally related to mobile communications and, more particularly, to methods and systems for improving the communication range, power consumption, and charging time for Ambient Internet of Things (A-IoT) devices with respect to user equipment (UE) and network apparatus in mobile communications.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a reader device. The reader device transmits an incident signal to an ambient internet of things (A-IoT) device. The reader device receives a response from the A-IoT device. The reader device adjusts a power of the incident signal based on a status of the response such that the power of the incident signal is at a level sufficient for communication with the A-IoT device while controlling interference with other devices.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7(A) is a diagram illustrating an example wireless communication system including a base station and a UE.

FIG. 7(B) is a diagram illustrating an example communication link between a gNB and an A-IoT device though a connection with a UE via a wired cable.

FIG. 7(C) is a diagram illustrating an example communication link between a gNB and an A-IoT device though a connection with a UE via a wireless air interface.

FIG. 8(A) is a diagram illustrating a first type of an A-IoT device.

FIG. 8(B) is a diagram illustrating a second type of an A-IoT device.

FIG. 8(C) is a diagram illustrating a third type of an A-IoT device.

FIG. 9(A) is a diagram illustrating an example communication link between a UE and an A-IoT device via an air interface.

FIG. 9(B) is a diagram illustrating an example communication process between a UE reader/gNB and an A-IoT device based on a chosen time duration.

FIG. 10 is a sequence diagram that describes a modified 4-step RACH procedure.

FIG. 11 is a sequence diagram that describes a modified 2-step RACH procedure.

FIG. 12 is a sequence diagram that describes a modified RACH procedure where a UE acts as a tag reader.

FIG. 13(A) is a sequence diagram that describes a modified Sidelink procedure where a RN16 is used.

FIG. 13(B) is a sequence diagram that describes a modified Sidelink procedure where a RN is used.

FIG. 14(A) is a diagram illustrating an issue of UL power control.

FIG. 14(B) is a diagram illustrating another issue of UL power control.

FIG. 15 is a sequence diagram for the UE reader/gNB and A-IoT device interaction.

FIG. 16 is another sequence diagram for the UE reader/gNB and A-IoT device interaction.

FIG. 17 illustrates an example communication system having an example communication apparatus and an example network apparatus.

FIG. 18(A) is a flow chart of a process for UL power control regarding a reader device and an A-IoT device.

FIG. 18(B) is a flow chart of another process for UL power control regarding a reader device and an A-IoT device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

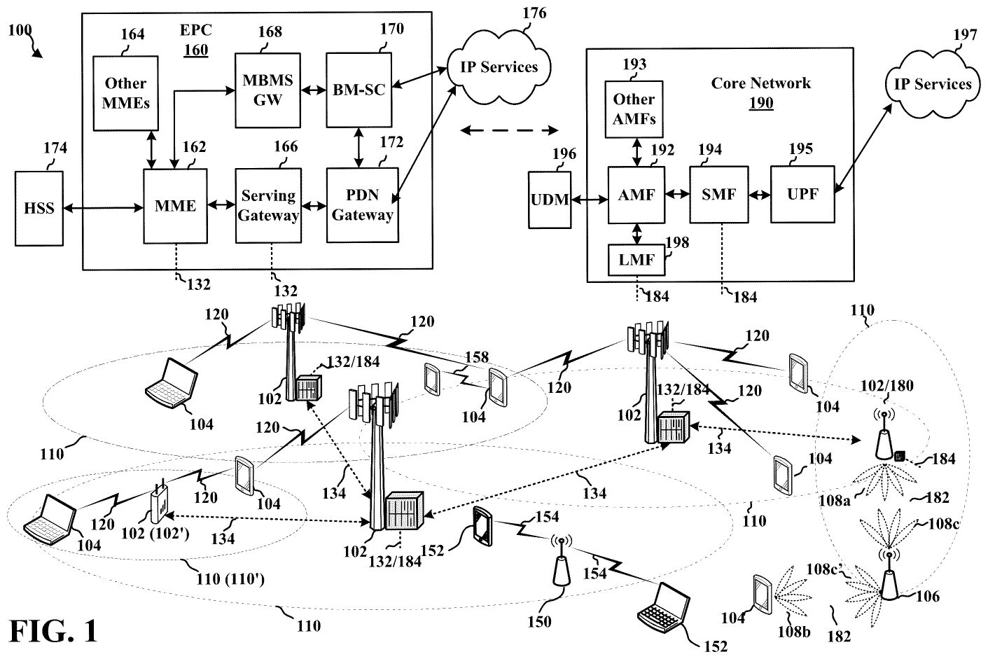

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (CNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

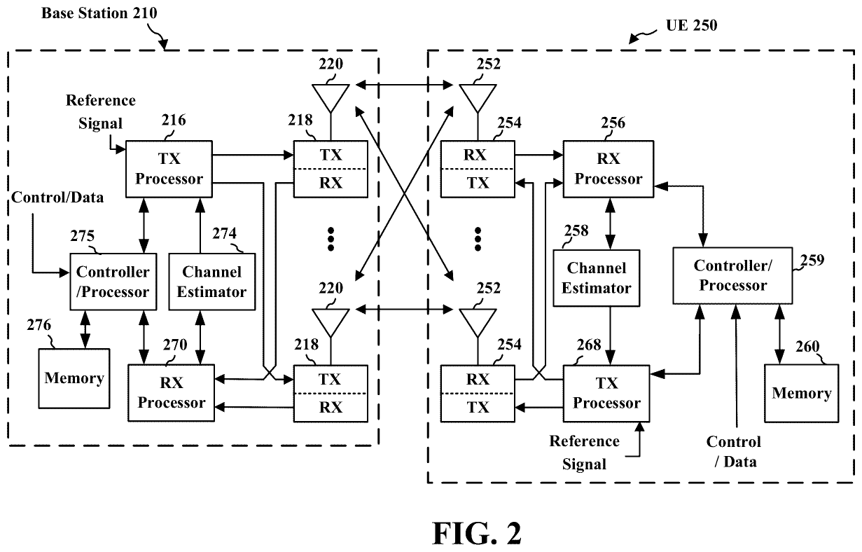

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

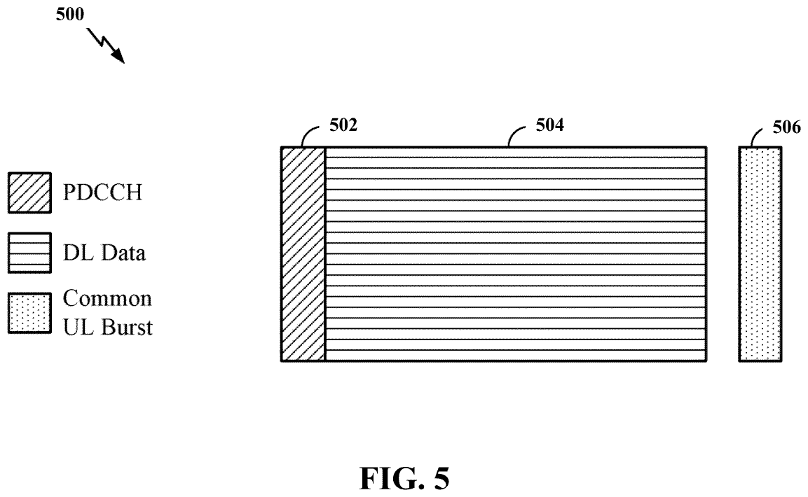

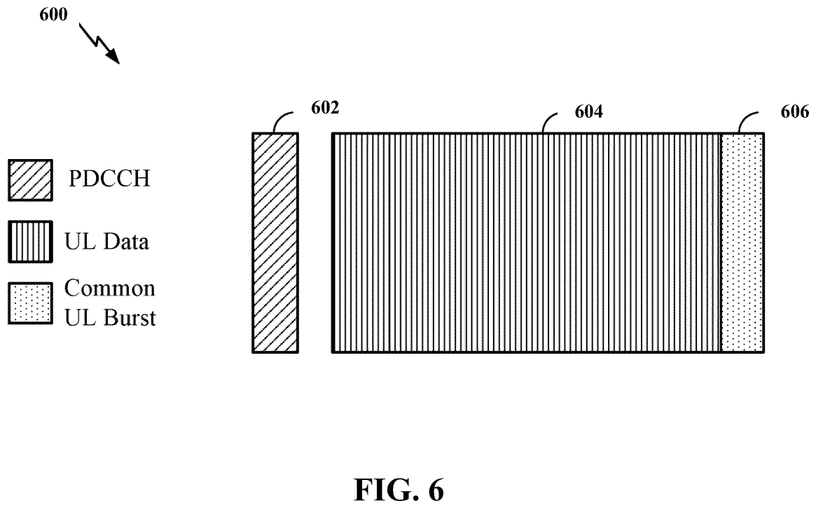

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

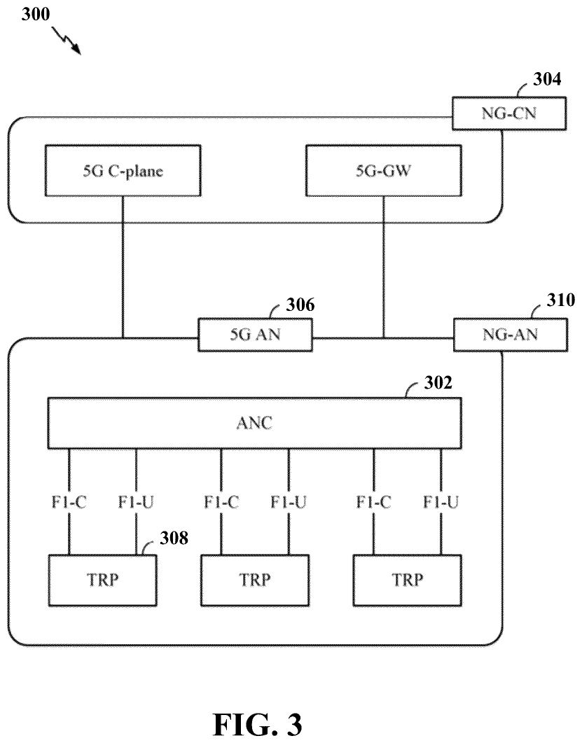

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

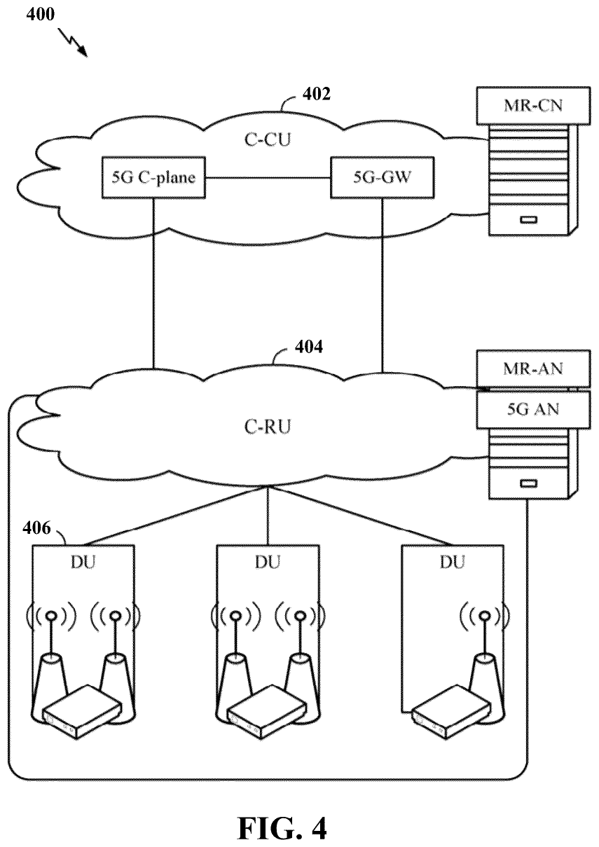

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

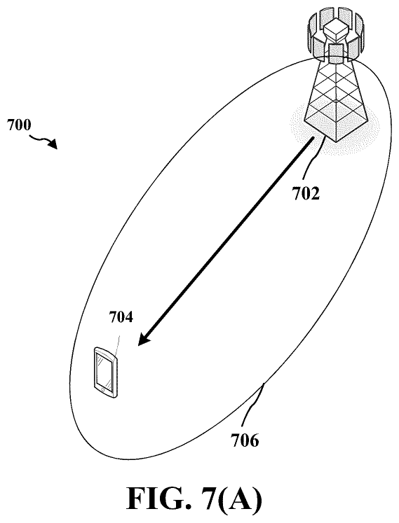

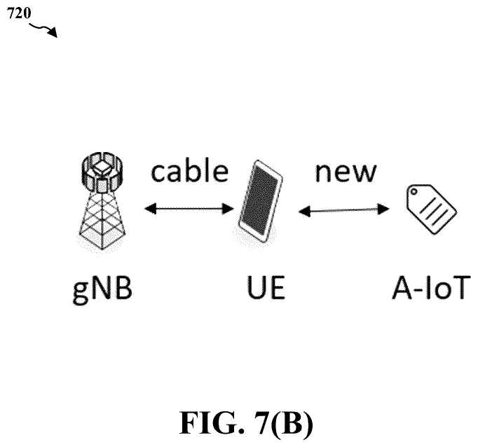

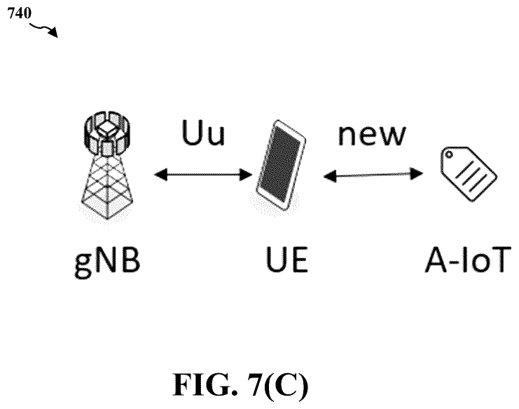

FIG. 7(A) is a diagram 700 illustrating an example wireless communication system including a base station and a UE. In this example, a UE 704 is connected to a base station 702 on a cell 706.

A-IoT devices often have limitations in terms of communication range, power consumption, and charging time. For instance, certain devices have a maximum coverage that is less than the maximum distance requirements for indoor use cases due to the activation power threshold. Increasing the transmit power can achieve the required range but may interfere with nearby base stations. Furthermore, the activation threshold of some devices depends on the rectifier's activation threshold in the RF energy harvester, leading to uncertainty for the base station to discover the device in a cell, especially when the device has low battery level or no battery.

The increasing use of IoT devices brings challenges in power management, with manual battery replacement or recharging being impractical due to cost, environmental, and safety factors. Existing technologies like barcodes and RFID also face limitations in reading range and interference. Therefore, there is a need for new IoT technologies that can support batteryless devices or those with energy storage that don't require manual intervention. The aim is to create a solution within 3GPP systems that can handle a high number of connections and device density, while reducing complexity and power consumption, thereby opening new markets and adding value across the value chain.

The present disclosure provides methods and systems for improving the communication range, power consumption, and charging time for A-IoT devices. The disclosure includes techniques for increasing the transmit power to achieve the required range while minimizing interference with nearby base stations. The disclosure also includes techniques for optimizing the activation threshold of devices based on the rectifier's activation threshold in the RF energy harvester, thereby reducing uncertainty for the base station to discover the device in a cell. Furthermore, the disclosure includes techniques for reducing the charging time for devices, particularly when using RF energy.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### System Topology

FIG. 7(B) is a diagram 720 illustrating an example communication link between a gNB and an A-IoT device though a connection with a UE via a wired cable. The present disclosure introduces a novel system topology for Ambient Internet of Things (A-IoT) communication. As shown in FIG. 7(B), the next-generation NodeB (gNB) establishes a connection with User Equipment (UE) or a UE reader via a wired cable. This configuration eliminates the need for a new air interface between the gNB and the A-IoT device, instead introducing a new air interface between the UE reader and the A-IoT device. As a result, the efforts required for any gNB specification change are significantly reduced. In this setup, the gNB can access the A-IoT device via the UE reader, which acts as an intermediate node between the device and the base station (gNB).

FIG. 7(C) is a diagram 740 illustrating an example communication link between a gNB and an A-IoT device though a connection with a UE via a wireless air interface. As shown in FIG. 7(C), a wireless air interface is established between the gNB and a UE or a UE reader. This air interface leverages the NR-Uu interface to minimize the specification change on the UE side. A new air interface between the UE and the A-IoT device is necessitated, the specifications of which can be determined based on the use cases and their corresponding requirements.

### Receiver Architectures

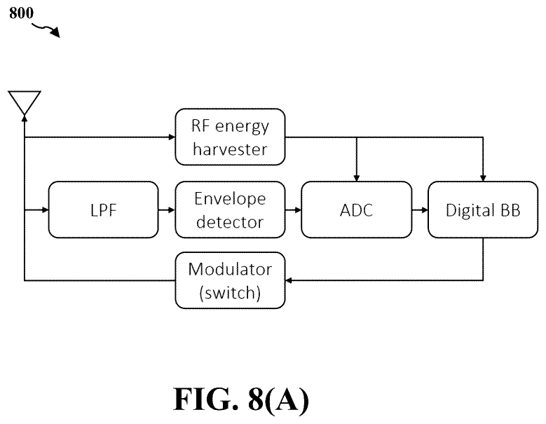

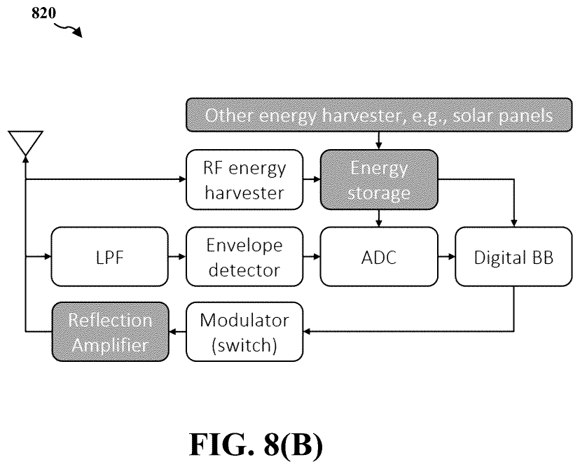

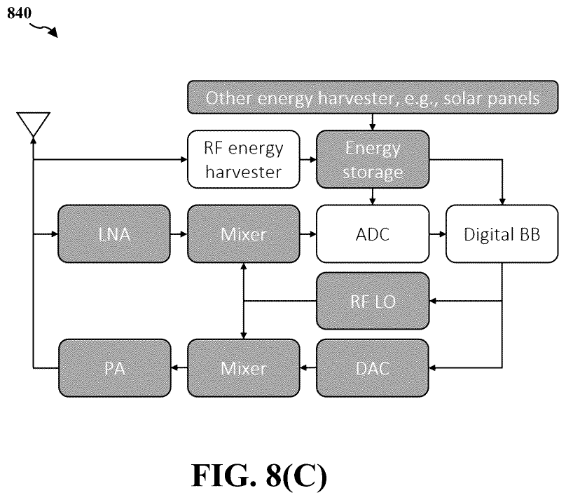

FIG. 8(A) is a diagram 800 illustrating a first type of an A-IoT device. Device A is designed with specific targets for power consumption during transmission/reception (≤1 μW or ≤10 μW), and complexity, which is aimed to be comparable to UHF RFID ISO18000-6C (EPC C1G2). Device A does not have energy storage or independent signal generation/amplification capabilities, and relies on backscattering transmission. It requires a backscattering activation power threshold, experiences reflection loss, and needs a distant carrier wave source to transmit signals for positioning.

The architecture of Device A includes the following components:
A low pass filter (LPF) for suppressing adjacent sub-carrier interference (ASCI) and adjacent carrier interference (ACI);
An envelope detector (ED) to support On-Off Keying (OOK)-based signals;
An analog to digital converter (ADC) for digital baseband processing;
A digital baseband (DBB) for sequence matching;
A modulator (switch) controlled by the incoming signal to add payload data for OOK modulation; and
A radio frequency energy harvester to convert RF signals into an energy source.

FIG. 8(B) is a diagram 820 illustrating a second type of an A-IoT device. Device B's design targets lie between those of Device A and Device C in terms of power and complexity. It has energy storage but no independent signal generation, relying on backscattering transmission. Stored energy can be used for signal amplification. Device B also requires a backscattering activation power threshold, experiences reflection loss, and needs a distant carrier wave source for positioning.

The architecture of Device B includes the following components:
An LPF for suppressing ASCI and ACI;
An ED to support OOK-based signals;
An ADC for digital baseband processing;
A DBB for sequence matching;
A modulator controlled by the incoming signal to add payload data for OOK modulation;
An RF energy harvester to convert RF signals into an energy source;
Additional energy harvesters for different types of ambient power sources, such as RF radio, solar energy, thermal energy, and piezoelectric power;
Energy storage, such as capacitors and solid-state batteries; and
A reflection amplifier to amplify the input signal to the tag and the backscattered signal towards the reader.

FIG. 8(C) is a diagram 840 illustrating a third type of an A-IoT device. Device C is designed with a power consumption target during transmission/reception of ≤1 mW to ≤10 mW, and a complexity target that is orders-of-magnitude lower than NarrowBand IoT (NB-IoT). Device C has energy storage, independent signal generation, and active RF components for transmission. It also has mobility management capabilities, at least for cell selection/re-selection.

The architecture of Device C includes the following components:
An LPF for suppressing ASCI and ACI;
An ED to support OOK-based signals;
An ADC for digital baseband processing;
A DBB for synchronization, payload decoding, and cyclic redundancy check (CRC)
An RF energy harvester to convert RF signals into an energy source;
Additional energy harvesters for different types of ambient power sources, such as RF radio, solar energy, thermal energy, and piezoelectric power;
Energy storage, such as capacitors and solid-state batteries; and
A low-noise amplifier (LNA) and power amplifier (PA) to amplify reception and transmission signals.

### New Air Interface

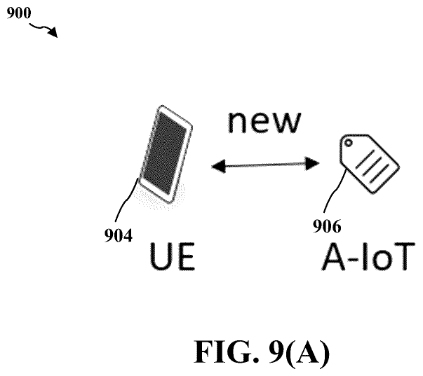

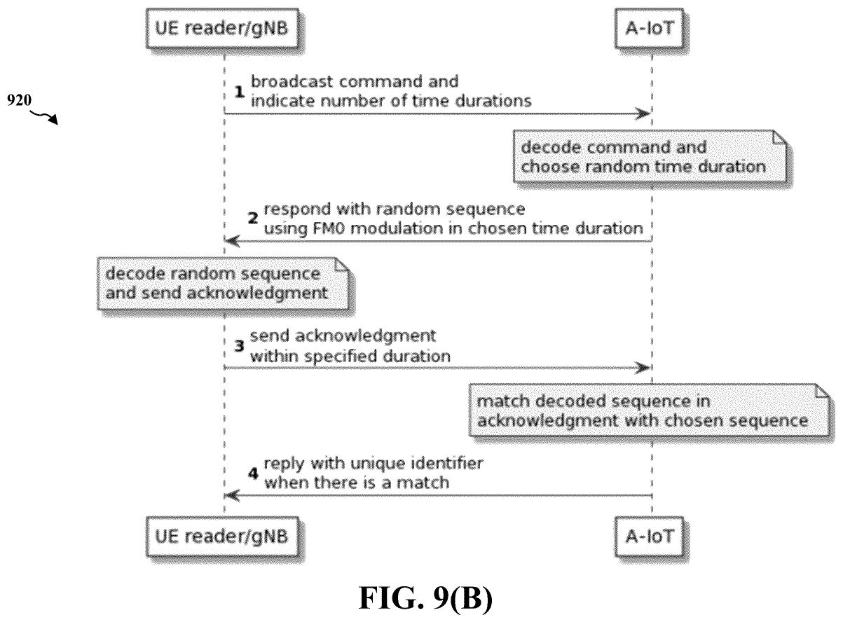

FIG. 9(A) is a diagram 900 illustrating an example communication link between a UE such as the UE 904 and an A-IoT device such as the A-IoT device 906 via an air interface. The disclosure presents an innovative air interface for communication between User Equipment (UE) reader or a base station (gNB) and the Ambient Internet of Things (A-IoT) device. The communication process is initiated when the UE reader powers up the A-IoT device and transmits a command. This command outlines essential communication parameters such as the tag rate, the tag data encoding method, and the total number of available time durations.

Once the A-IoT device has harvested enough energy, it gets activated and listens for the UE's command. After decoding the command, the A-IoT device randomly selects a time duration from the available range, and generates a random sequence. This sequence is then transmitted in the chosen time duration, preceded by a known preamble sequence.

In response to the A-IoT's transmission, the UE decodes the received preamble sequence and sends an acknowledgment back to the A-IoT within a predetermined duration, aligning with the system's configuration for the A-IoT rate.

The UE or UE reader discussed above is a node that can be a relay, IAB node, NR/LTE UE, repeater, or a base station (gNB).

FIG. 9(B) is a diagram 920 illustrating an example communication process between a reader device and an A-IoT device based on a chosen time duration. The User Equipment to Ambient IoT Device Communication Link (U2A Link) uses modulation schemes like Amplitude Shift Keying (ASK) or On-Off Keying (OOK) to facilitate Pulse Interval Encoding (PIE) for data transmission. The U2A link includes two preambles: a long U2A preamble for initial transmission and a short U2A preamble for subsequent signaling. The UE transmits the long U2A preamble and a control signal or command, specifying control parameters for the A-IoT device.

The Ambient IoT Device to User Equipment Communication Link (A2U Link) employs either ASK or Phase Shift Keying (PSK) modulation. The A-IoT encodes backscattered data using either FM0 baseband or Miller modulation, as controlled by the UE or gNB via the A2U link. The A2U link signaling commences with one of two Miller Subcarrier Preambles, depending on the command or the control signal. The A-IoT employs backscatter modulation, altering its antenna's reflection coefficient to transmit data. The A2U link transmits Electronic Product Code (EPC) and Protocol-Control Information (PC).

### Modified 4-Step RACH

Considering that the A-IoT (Ambient IoT) device can only perform ASK (Amplitude Shift Keying) or OOK (On-Off Keying) modulation and backscattering communication, and that the Downlink (DL) signals can be PSS (Primary Synchronization Signal), SSS (Secondary Synchronization Signal), and OOK-based Low Power Wake-Up Signal (LP-WUS), the modified 4-step RACH procedure could be as follows:

1. DL Signal Reception: The A-IoT device listens for the PSS, SSS, or LP-WUS from the gNB or UE reader. These signals serve as an “inquiry command” for the A-IoT device. For example, the LP-WUS, specifically designed to wake up devices from a low-power state, could be particularly useful for A-IoT devices. Upon detecting one of these signals, the A-IoT device wakes up and prepares for further communication.

2. Preamble Transmission (Msg1): Upon receiving the DL signal, the A-IoT device generates a random 16-bit number (RN16) and sends it back to the gNB or UE reader. This is done through backscattering communication, using ASK or OOK modulation. This is similar to the RFID tag sending the RN16 to the reader in response to the inquiry command.

3. Random Access Response (Msg2): The gNB or UE reader sends an acknowledgment signal back to the A-IoT device, which includes the RN16. This acknowledgment could be sent on a specific DL channel that the A-IoT device is programmed to monitor. The A-IoT device, upon receiving this acknowledgment, knows that the gNB or UE reader has successfully received its RN16.

4. RRC Connection Request (Msg3): Once the A-IoT device receives the acknowledgment, it sends its Electronic Product Code (EPC) to the gNB or UE reader. This is done through backscattering communication, using ASK or OOK modulation. This EPC is a unique identifier for the A-IoT device, similar to the unique identifier of an RFID tag.

5. Contention Resolution (Msg4): The gNB or UE reader sends a contention resolution message to the A-IoT device, confirming the A-IoT device's EPC and completing the RACH procedure. This step ensures that the A-IoT device has been correctly identified and that there are no collisions with other A-IoT devices. The contention resolution message could include the EPC of the A-IoT device, so the device knows that the message is intended for it.

This modified 4-step RACH procedure aligns more closely with the RFID protocol, with the A-IoT device acting as the RFID tag and the gNB or UE reader acting as the RFID reader.

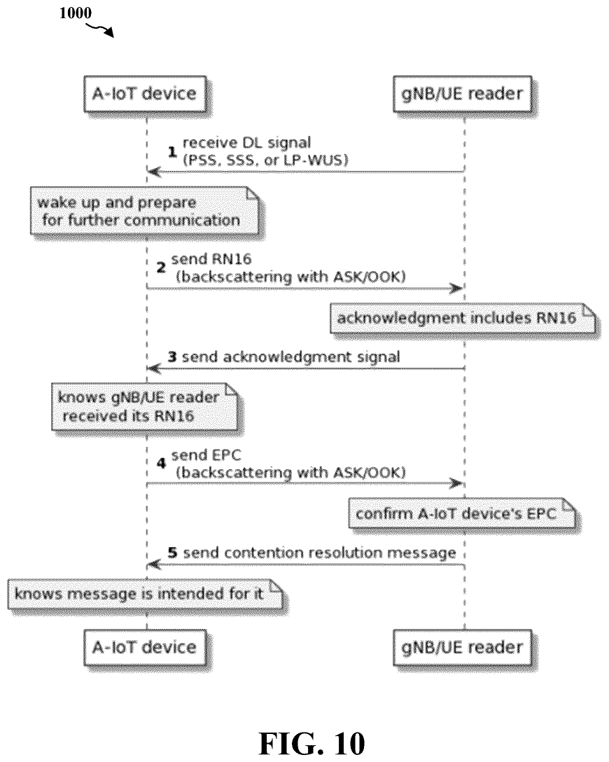

FIG. 10 is a sequence diagram 1000 that describes the modified 4-step RACH procedure. In this diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

### Modified 2-Step RACH

This subsection elucidates a proposed modification to the 2-step Random Access Channel (RACH) procedure, designed to accommodate the characteristics of Ambient Internet of Things (A-IoT) devices. The modification aligns with the RFID protocol and takes into account the A-IoT device's capabilities for Amplitude Shift Keying (ASK) or On-Off Keying (OOK) modulation and backscattering communication.

The procedure comprises two main stages:

1. Downlink Signal Transmission and Preamble Transmission (Msg1): The gNB or UE reader initiates the process by transmitting a Downlink (DL) signal, accompanied by a random 16-bit number (RN16), to the A-IoT device. The DL signal could be a Primary Synchronization Signal (PSS), Secondary Synchronization Signal (SSS), or Low Power Wake-Up Signal (LP-WUS), serving as an “inquiry command” for the A-IoT device. For instance, the gNB could dispatch a DL signal (PSS) along with an RN16 (1011 1100 0011 1110). The A-IoT device, upon receiving this signal, harnesses it to charge its battery.

2. Random Access Response and Contention Resolution (Msg2): In the subsequent stage, the A-IoT device validates the received RN16 against its tag ID. Upon a match, the A-IoT device reciprocates by transmitting the RN16 and its unique Electronic Product Code (EPC) to the gNB or UE reader, leveraging backscattering communication with ASK or OOK modulation. To illustrate, if the RN16 aligns with the tag ID of the A-IoT device, the device responds by backscattering the RN16 (1011 1100 0011 1110) and its EPC (e.g., 0000 1010 1111 0000). The gNB or UE reader, upon successful reception of the EPC, completes the RACH procedure by sending a final acknowledgment to the A-IoT device.

This modification to the 2-step RACH procedure brings it closer to the RFID protocol, casting the A-IoT device in the role of the RFID tag and the gNB or UE reader as the RFID reader. However, this is a simplified representation and may not encapsulate all facets of the NR and RFID protocols.

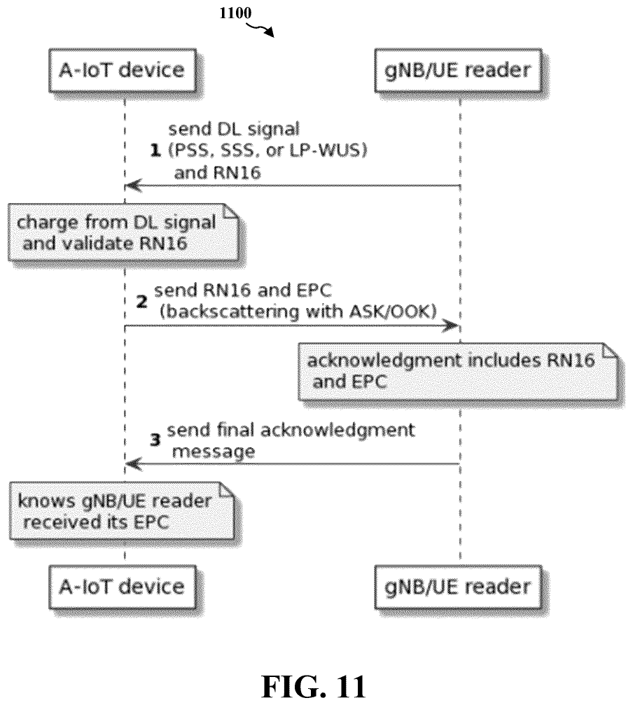

FIG. 11 is a sequence diagram 1100 that describes a modified 2-step RACH procedure. In this sequence diagram, the “A-IoT device” participant stands for the A-IoT device, and the “gNB/UE reader” participant signifies the gNB or UE reader. The arrows denote the communication between the two participants, while the notes offer additional details about the behavior of each participant at each step of the procedure.

This diagrammatic representation aligns with the modified 2-step RACH procedure, which is designed to mimic the RFID protocol. The A-IoT device acts as the RFID tag and the gNB or UE reader plays the role of the RFID reader. It's important to note that this is a simplified model and might not encapsulate all aspects of the NR and RFID protocols. Real-world implementations could necessitate additional measures to manage errors, retransmissions, and security considerations. This sequence diagram serves as a high-level overview of the procedure, providing a foundation for further detailing based on specific implementation requirements.

### Modified RACH Procedure (UE Acting as a Tag Reader)

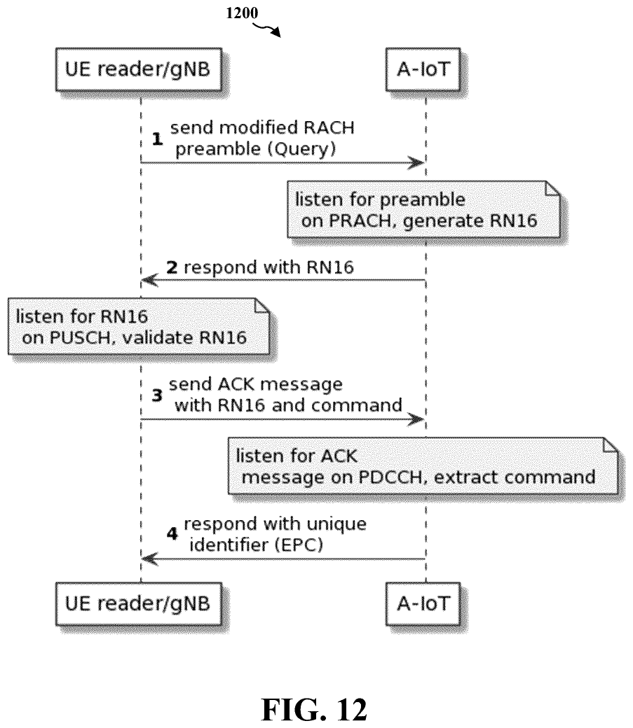

FIG. 12 is a sequence diagram 1200 that describes a modified RACH procedure where a UE acts as a tag reader. As shown in FIG. 12, this modification allows a User Equipment (UE), acting as a reader, to communicate with Ambient Internet of Things (A-IoT) devices, acting as tags.

1. Preamble (Query): The UE (acting as the reader) initiates the process by sending a modified RACH preamble. This preamble is broadcast to all tags in its vicinity. This serves as the “Query” in the RFID protocol. The modified preamble could be sent over the Physical Random Access Channel (PRACH). The preamble could contain a specific sequence or pattern that the tags are programmed to recognize. For example, the preamble could start with a specific bit pattern followed by the UE's unique identifier.

The UE's behavior would involve generating the preamble and transmitting it over the PRACH. The UE would need to ensure that the preamble is detectable by the tags, which might require a change in the format or power level of the preamble.

2. Response (RN16): Upon detecting the preamble, each tag generates a random 16-bit number (RN16) and responds with it. This would be similar to the RACH Response in the current procedure. The tags would need to have the capability to generate and transmit this RN16, which is not a feature of traditional RFID tags. This would require modifications to the tag's firmware and possibly hardware. The response could be sent over the Physical Uplink Shared Channel (PUSCH).

The A-IoT device's behavior would involve listening for the preamble on the PRACH, generating the RN16 upon detecting the preamble, and transmitting the RN16 over the PUSCH.

3. Connection Setup (ACK): The UE listens for responses from the tags. Upon receiving a valid RN16 from a tag, the UE sends a modified Connection Setup message to that tag. This serves as the “ACK” in the RFID protocol. The UE would need to be modified to generate and send this ACK message. The ACK message could be sent over the Physical Downlink Control Channel (PDCCH) and could contain the RN16 and a command instructing the tag to transmit its unique identifier.

The UE's behavior would involve listening for the RN16 on the PUSCH, validating the RN16, and transmitting the ACK message over the PDCCH.

4. Data Transmission (EPC): Upon receipt of the ACK message, the tag responds with its unique identifier. This would be similar to the EPC in the RFID protocol. The tag would need to be modified to store its unique identifier and transmit it upon receipt of the ACK message. The unique identifier could be sent over the PUSCH.

The A-IoT device's behavior would involve listening for the ACK message on the PDCCH, extracting the command from the ACK message, and transmitting its unique identifier over the PUSCH.

This would require significant changes to both the UE and the tags, including hardware and firmware modifications.

Absolutely, based on the context provided, FIG. 12 illustrates how a part of a technical report might look like with a PlantUML Sequence Diagram.

The proposed modification of the 5G NR RACH procedure allows a User Equipment (UE), acting as a reader, to communicate with Ambient Internet of Things (A-IoT) devices, acting as tags.

### Modified Sidelink Procedure

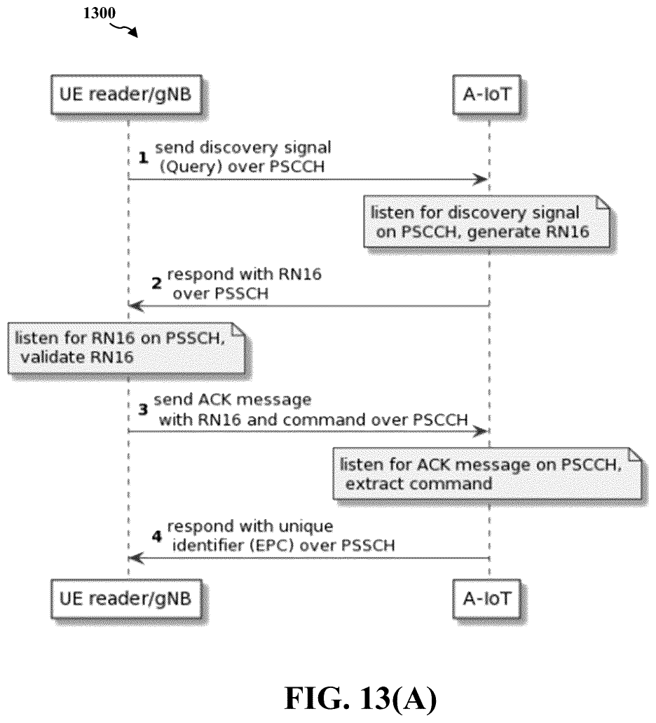

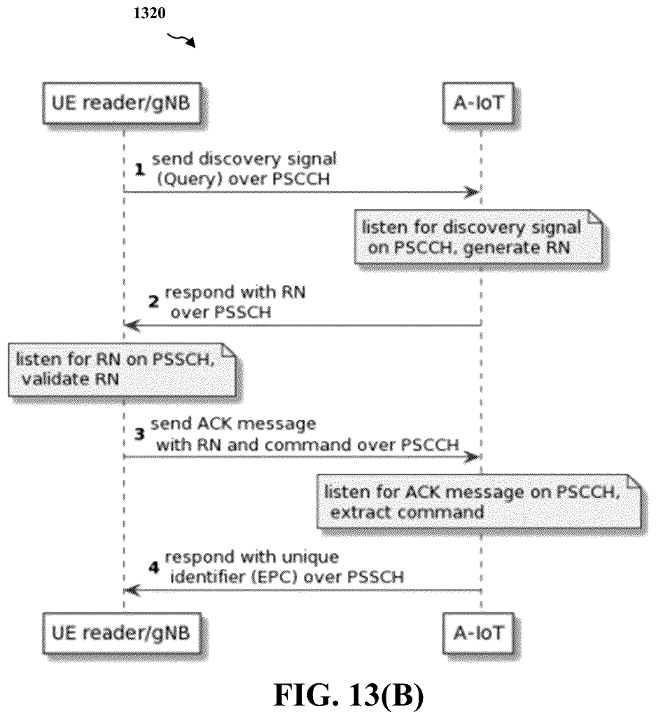

FIG. 13(A) is a sequence diagram 1300 that describes a modified Sidelink procedure where a RN16 is used. This approach allows a User Equipment (UE), acting as an RFID reader, to interact with Ambient Internet of Things (A-IoT) devices, functioning as RFID tags. The following messages can be transmitted in a dedicated resource set and/or a shared resource set. In addition, the following message can be transmitted before link establishment and/or during link establishment. For the case of before link establishment, for example, one or multiple messages(s) can be transmitted by a aperiodic signal (e.g., standalone channel state information-reference signal (CSI-RS)) and/or periodic signal (e.g., modified a synchronization signal block (SSB)). For the case of during link establishment, for example, one or multiple message(s) can be transmitted during discovery message/link establishment by a standalone CSI-RS, and/or non-standalone CSI-RS, and/or DMRS. Further, the container of one or multiple message(s) in this case can be a channel w/(pre-) configured resource (i.e., explicit manner), and/or channel w/scheduled/indicated resource (i.e., inexplicit manner).

In the following specific procedures, control/data channel during the discovery link establishment as the container for the one or multiple message transmission(s) is taken as an example.

1. Discovery Signal (Query): The UE (acting as the reader) sends a discovery signal to all tags in its vicinity. This serves as the “Query” in the RFID protocol. The discovery signal could be sent over the control channel (e.g., Physical Sidelink Control Channel (PSCCH)). The signal could contain a specific sequence or pattern that the tags are programmed to recognize. For example, the signal could start with a specific bit pattern followed by the UE's unique identifier.

The UE's behavior would involve generating the discovery signal and transmitting it over the PSCCH. The UE would need to ensure that the signal is detectable by the tags, which might require a change in the format or power level of the signal.

2. Discovery Response (RN16): Upon detecting the discovery signal, each tag generates a random 16-bit number (RN16) and responds with it. This would be analogous to the Discovery Response in the current sidelink procedure. The tags would need to be modified to generate and transmit this RN16. The response could be sent over the data channel (e.g., Physical Sidelink Shared Channel (PSSCH)).

The A-IoT device's behavior would involve listening for the discovery signal on the PSCCH, generating the RN16 upon detecting the signal, and transmitting the RN16 over the PSSCH.

3. Sidelink Connection Setup (ACK): The UE listens for responses from the tags. Upon receiving a valid RN16 from a tag, the UE sends a Sidelink Connection Setup message to that tag. This serves as the “ACK” in the RFID protocol. The UE would need to be modified to generate and send this ACK message. The ACK message could be sent over the PSCCH and could contain the RN16 and a command instructing the tag to transmit its unique identifier.

The UE's behavior would involve listening for the RN16 on the PSSCH, validating the RN16, and transmitting the ACK message over the PSCCH.

4. Data Transmission (EPC): Upon receipt of the ACK message, the tag responds with its unique identifier. This would be similar to the EPC in the RFID protocol. The tag would need to be modified to store its unique identifier and transmit it upon receipt of the ACK message. The unique identifier could be sent over the PSSCH.

The A-IoT device's behavior would involve listening for the ACK message on the PSCCH, extracting the command from the ACK message, and transmitting its unique identifier over the PSSCH.

This would require significant changes to both the UE and the tags, including hardware and firmware modifications.

FIG. 13(A) illustrates a part of a technical report with a PlantUML Sequence Diagram.

FIG. 13(B) is a sequence diagram 1320 that describes a modified Sidelink procedure where a RN is used. To harness the power of 5G New Radio (NR) for RFID-like communication, the present disclosure proposes a modified Sidelink procedure. This approach allows a User Equipment (UE), acting as an RFID reader, to interact with Ambient Internet of Things (A-IoT) devices, functioning as RFID tags.

In some embodiments, the approach enables a User Equipment (UE), functioning as an RFID reader, to interact with Ambient Internet of Things (A-IoT) devices, serving as RFID tags.

5. Discovery Signal (Query): The UE dispatches a discovery signal to all tags within its range, serving as the “Query” in the RFID protocol. This discovery signal could be transmitted over a dedicated or shared resource set, and could be sent using a aperiodic resource (e.g., standalone CSI-RS) or periodic resource (e.g., modified SSB) before link establishment. The signal could contain a specific sequence or pattern recognizable by the tags. For instance, the signal could initiate with a specific bit pattern followed by the UE's unique identifier.

The UE's role would involve generating and transmitting the discovery signal. The UE should ensure that the signal is detectable by the tags, which might necessitate a change in the signal's format or power level.

6. Discovery Response (RN): Upon detecting the discovery signal, each tag generates a random number (RN) and responds with it. This RN could be 16-bit as an example, but the exact number of bits may need to be further investigated. This is analogous to the Discovery Response in the current sidelink procedure. The tags would need to be modified to generate and transmit this RN. The response could be sent over the control channel (e.g., Physical Sidelink Shared Channel (PSSCH)) or during discovery message/link establishment by a standalone CSI-RS, non-standalone CSI-RS, or DMRS.

The A-IoT device's role would involve listening for the discovery signal, generating the RN upon signal detection, and transmitting the RN.

7. Sidelink Connection Setup (ACK): The UE listens for responses from the tags. Upon receiving a valid RN from a tag, the UE sends a Sidelink Connection Setup message to that tag. This serves as the “ACK” in the RFID protocol. The UE would need to be modified to generate and send this ACK message. The ACK message could be sent over the PSCCH and could contain the RN and a command instructing the tag to transmit its unique identifier.

The UE's role would involve listening for the RN, validating the RN, and transmitting the ACK message.

8. Data Transmission (EPC): Upon receipt of the ACK message, the tag responds with its unique identifier. This would be similar to the EPC in the RFID protocol. The tag would need to be modified to store its unique identifier and transmit it upon receipt of the ACK message. The unique identifier could be sent over the data channel (e.g., PSSCH).

The A-IoT device's role would involve listening for the ACK message, extracting the command from the ACK message, and transmitting its unique identifier.

This approach would necessitate substantial changes to both the UE and the tags, including hardware and firmware modifications.

The messages described above can be transmitted in dedicated or shared sidelink resource pools, before or during link establishment. The containers for these messages can be a pre-configured channel (e.g., PSFCH-like), scheduled/indicated channel (e.g., PSCCH/PSSCH), or others. The PSCCH/PSSCH used here is taken as an example. Further discussion and synchronization are encouraged to explore other potential options. The RN16 used in the Discovery Response is taken as an example, and the exact number of bits may need to be further investigated.

In another aspect, for the topology described in this disclosure, different resource allocation and scheduling methods are disclosed. The resource allocation for the link between intermediate UE and A-IoT device can be scheduled/configured by gNB via DCI, and/or configured grant (CG), and/or (pre-) configured resource pool. For the manner of DCI, one or multiple resource(s) can be indicated for one transmission from intermediate UE to A-IoT device(s). For the manner of CG, one or multiple resource(s) can be indicated for one or multiple transmission(s) from intermediate UE to A-IoT device(s). In addition, in this case, a further signaling can be used in a DCI to indicate whether the resource(s) by CG can be used or not. For example, after a set of resource(s) are configured, a further signaling in DCI can be used to active or de-active the configured resource. Only when the intermediate UE receive the activation in the DCI, it can use the configured resource for transmission to the A-IoT device. In addition, for the manner of (pre-) configured resource pool, it depends on the intermediate UE to further select one or multiple resource(s) for one or multiple transmission to A-IoT device.

In another aspect, the gNB can control the search for A-IoT device. For example, the gNB can indicate the intermediate UE to search one or multiple specific A-IoT device(s), or just blind searching of one or multiple A-IoT device(s) within one-bit length indicator in DCI. For the case of specific A-IoT device(s) searching indicated in the DCI, one or multiple identifier(s) of one or multiple specific A-IoT(s) (e.g., each by a destination ID w/a length of N bits) can be controlled by the gNB and transmitted in a new field in DCI. The one or multiple identifier(s) will be used by the intermediate UE to further search one or multiple specific A-IoT device(s). Alternatively, the gNB can also indicate a blind searching of one or multiple A-IoT device(s). In this case, the intermediate UE can determine the searching procedure of A-IoT device(s). For example, a service type identifier can be used by the intermediate UE to identify one or multiple A-IoT device(s) satisfying the service type.

### UL Power Control

Device A, a type of passive device, has its activation threshold directly linked to its power consumption. This means that the output of the RF energy harvester must be equal to or exceed the power consumption of Device A for it to function effectively.

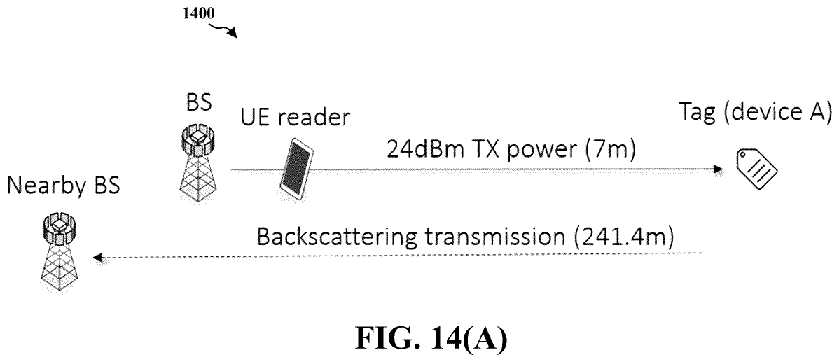

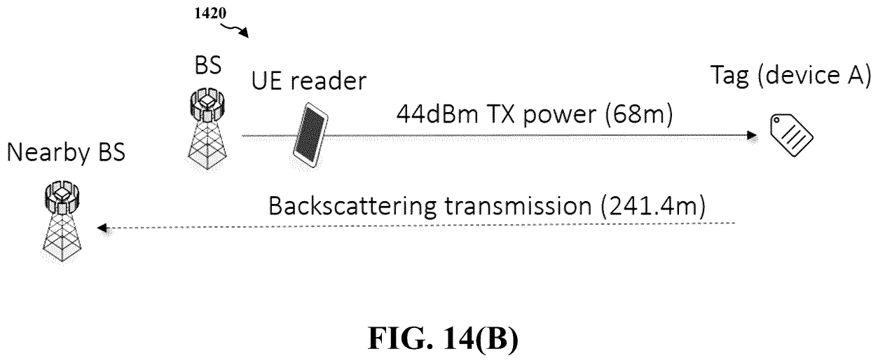

FIG. 14(A) is a diagram 1400 illustrating an issue of UL power control. For example, if Device A consumes 1 μW for transmission or reception, an RF harvester output of 0.25 μW (equivalent to a received signal power of-30 dBm) would be insufficient. To meet the power consumption needs of Device A, the received RF signal power must exceed 4 μW, considering an energy conversion efficiency of 25% to 50%. This translates to an activation threshold of-27 dBm to-24 dBm for Device A.

However, there is a significant issue with this activation threshold. Given the activation power threshold of-20 dBm, Device A can only achieve a maximum coverage of 7m for an indoor base station with 24 dBm EIRP. This falls short of the maximum distance requirements for indoor settings, which range from 10 to 50 m as per TR 38.848.

FIG. 14(B) is a diagram 1420 illustrating another issue of UL power control. As shown in FIG. 14(B), increasing the transmit power to 44 dBm can extend the range to 68m, thereby meeting the indoor coverage requirement of 10-50m. However, this solution presents another problem: the backscattering transmission from Device A can interfere with nearby base stations.

For Device A, the UL power control can be adjusted either by changing the base station power or by altering the antenna impedance. For Device B, the UL power control can be regulated by a reflecting amplifier, based on factors such as battery level, battery voltage, battery current, channel condition, and power requirement.

Passive Device without Reflection Amplifier

In a backscatter communication system, the uplink (UL) power is primarily determined by the power of the incident signal and the reflection coefficient of the backscatter device. However, the backscatter device does not generate its own signal, instead, it modulates and reflects an incident signal. Therefore, controlling the UL power in a backscatter system typically involves controlling the power of the incident signal and the reflection coefficient of the backscatter device.

1. Adjusting the Incident Signal Power: The power of the incident signal from the UE reader or gNB can be adjusted. The stronger the incident signal, the stronger the reflected signal will be.

2. Modifying the Reflection Coefficient: The reflection coefficient of the backscatter device can be adjusted by changing the impedance of the antenna on the backscatter device. This allows the backscatter device to modulate the reflected signal to encode information.

### Adjusting the Incident Signal Power

In the given protocol, the UE reader or gNB initiates the communication and powers up the A-IoT device. The A-IoT device then responds with a random sequence in a chosen time duration. The UE reader or gNB acknowledges this transmission, and the A-IoT device replies with a unique identifier when there is a match.

To control the UL power in this scenario, the UE reader or gNB can adjust the power of the incident signal when it broadcasts the command to the A-IoT device. This can be done in several ways:

1. Fixed Power Level: The UE reader or gNB can transmit the command at a fixed power level that is suitable for the majority of the A-IoT devices.

2. Adaptive Power Control: The UE reader or gNB can adaptively adjust the power of the incident signal based on the estimated distance to the A-IoT device or based on the quality of the received signal from the A-IoT device.

3. Power Ramping: The UE reader or gNB can start transmitting the command at a low power level and gradually increase the power until the A-IoT device responds.

The effectiveness of these strategies will depend on the specific characteristics of the UE reader or gNB and the A-IoT device, as well as the environment in which they are deployed. It is recommended to conduct a detailed analysis and simulation to determine the most effective strategy for managing the UL power in this scenario.

### Modifying the Reflection Coefficient

In the given protocol, the A-IoT device modulates the reflected signal to encode information. This modulation process involves changing the impedance of the antenna on the A-IoT device, which in turn changes the reflection coefficient. Here's how:

1. Impedance Matching: The A-IoT device can have two states for its antenna impedance: a “matching” state where the antenna's impedance matches the impedance of the air (resulting in maximum power transfer and minimum reflection), and a “mismatching” state where the antenna's impedance does not match the impedance of the air (resulting in maximum reflection). By rapidly switching between these two states, the A-IoT device can modulate the reflected signal to encode information.

2. Electronic Switch: The A-IoT device can use an electronic switch to change the state of the antenna. When the switch is in one state, the antenna is in the “matching” state. When the switch is in the other state, the antenna is in the “mismatching” state. The A-IoT device can control the state of the switch based on the data it wants to transmit.

3. Energy Harvesting: The A-IoT device can use the energy it has harvested to power the electronic switch. This allows the A-IoT device to change the state of the antenna even when it is not receiving a signal from the UE reader or gNB.

In this way, the A-IoT device can control the power of the reflected signal by changing the impedance of its antenna, thus modifying the reflection coefficient. This allows the A-IoT device to modulate the reflected signal to encode information, as described in the given protocol.

In a first aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command to power up an A-IoT device, if the UE is in a state of initiating communication with the A-IoT device,
Determine the power of the incident signal to be transmitted to the A-IoT device, if the estimated distance to the A-IoT device or the quality of the received signal from the A-IoT device is known,
Perform adjustment of the power of the incident signal based on the determined power, if the UE is in a state of broadcasting the command to the A-IoT device,
Transmit, to the BS, an acknowledgment of the transmission, if the A-IoT device responds with a unique identifier.

In a second aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command to power up a specific A-IoT device, if the UE is in a state of initiating communication with the A-IoT device,
Determine the power of the incident signal to be transmitted to the A-IoT device, if the estimated distance to the A-IoT device or the quality of the received signal from the A-IoT device is known,
Perform adjustment of the power of the incident signal based on the determined power, if the UE is in a state of broadcasting the command to the specific A-IoT device,
Transmit, to the BS, an acknowledgment of the transmission, if the A-IoT device responds with a unique identifier.

In a third aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command to modulate a reflected signal, if the UE is in a state of communicating with an A-IoT device,
Determine the impedance of the antenna on the A-IoT device, if the A-IoT device is in a state of changing the impedance to modulate the reflected signal,
Perform adjustment of the reflection coefficient of the backscatter device by changing the impedance of the antenna, if the A-IoT device is in a state of encoding information,
Transmit, to the BS, a modulated reflected signal, if the A-IoT device is in a state of reflecting the incident signal.

In a fourth aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command to modulate a reflected signal, if the UE is in a state of communicating with an A-IoT device,
Determine the transmission power in response to the power of the received signal, if the A-IoT device is in a state of changing the impedance to modulate the reflected signal,
Perform adjustment of the transmission power by changing the impedance of the antenna or implementing a function, such as a log function, if the A-IoT device is in a state of encoding information,
Transmit, to the BS, a modulated reflected signal, if the A-IoT device is in a state of reflecting the incident signal.
   Passive Device with Reflection Amplifier

When a backscatter device is equipped with a reflection amplifier, it can amplify the reflected signal, thereby increasing the uplink (UL) power. This can be particularly useful in scenarios where the incident signal power is low or the distance between the backscatter device and the UE reader or gNB is large.

The UL power control can be achieved through the following methods:

1. Adjusting the Incident Signal Power: The power of the incident signal from the UE reader or gNB can be adjusted. The stronger the incident signal, the stronger the reflected signal will be, even before amplification.

2. Modifying the Reflection Coefficient: The reflection coefficient of the backscatter device can be adjusted by changing the impedance of the antenna on the backscatter device. This allows the backscatter device to modulate the reflected signal to encode information.

3. Controlling the Amplifier Gain: The gain of the reflection amplifier can be controlled to adjust the power of the reflected signal. This can be done dynamically based on the quality of the received signal at the UE reader or gNB, or based on the estimated distance to the UE reader or gNB.

4. Adaptive Power Control: The UE reader or gNB can adaptively adjust the power of the incident signal based on the estimated distance to the backscatter device or based on the quality of the received signal from the backscatter device. If the backscatter device is close or if the received signal quality is good, the UE reader or gNB can reduce the power of the incident signal. If the backscatter device is far or if the received signal quality is poor, the UE reader or gNB can increase the power of the incident signal.

5. Power Ramping: The UE reader or gNB can start transmitting the command at a low power level and gradually increase the power until the backscatter device responds. This can help to ensure that the power of the incident signal is just high enough to reach the backscatter device, thus minimizing the potential for interference or receiver overload.

The effectiveness of these strategies will depend on the specific characteristics of the UE reader or gNB and the backscatter device, as well as the environment in which they are deployed.

### Adjusting the Incident Signal Power

To implement the strategy based on the given protocol, the UE reader or gNB can adjust the power of the incident signal when it broadcasts the command to the A-IoT device. This can be done in several ways:

1. Fixed Power Level: The UE reader or gNB can transmit the command at a fixed power level that is suitable for the majority of the A-IoT devices. This power level should be chosen such that it is not too high for A-IoT devices that are close to the UE reader or gNB, but still high enough for A-IoT devices that are far away.

2. Adaptive Power Control: The UE reader or gNB can adaptively adjust the power of the incident signal based on the estimated distance to the A-IoT device or based on the quality of the received signal from the A-IoT device. If the A-IoT device is close or if the received signal quality is good, the UE reader or gNB can reduce the power of the incident signal. If the A-IoT device is far or if the received signal quality is poor, the UE reader or gNB can increase the power of the incident signal.

3. Power Ramping: The UE reader or gNB can start transmitting the command at a low power level and gradually increase the power until the A-IoT device responds. This can help to ensure that the power of the incident signal is just high enough to reach the A-IoT device, thus minimizing the potential for interference or receiver overload.

### Modifying the Reflection Coefficient

To implement the strategy, the A-IoT device can change the impedance of its antenna to modulate the reflected signal. This can be done in the following ways:

1. Impedance Matching: The A-IoT device can have two states for its antenna impedance: a “matching” state where the antenna's impedance matches the impedance of the air (resulting in maximum power transfer and minimum reflection), and a “mismatching” state where the antenna's impedance does not match the impedance of the air (resulting in maximum reflection). By rapidly switching between these two states, the A-IoT device can modulate the reflected signal to encode information.

2. Electronic Switch: The A-IoT device can use an electronic switch to change the state of the antenna. When the switch is in one state, the antenna is in the “matching” state. When the switch is in the other state, the antenna is in the “mismatching” state. The A-IoT device can control the state of the switch based on the data it wants to transmit.

3. Energy Harvesting: The A-IoT device can use the energy it has harvested to power the electronic switch. This allows the A-IoT device to change the state of the antenna even when it is not receiving a signal from the UE reader or gNB.

### Controlling the Amplifier Gain

To implement the strategy based on the given protocol, the A-IoT device can dynamically adjust the gain of the reflection amplifier. This can be done in the following ways:

1. Signal Quality-Based Control: The A-IoT device can estimate the quality of the received signal from the UE reader or gNB. If the signal quality is good, the A-IoT device can reduce the gain of the reflection amplifier. If the signal quality is poor, the A-IoT device can increase the gain of the reflection amplifier. This can be achieved by using a feedback loop that adjusts the gain based on the error between the estimated signal quality and a target signal quality.

2. Distance-Based Control: The A-IoT device can estimate the distance to the UE reader or gNB. If the A-IoT device is close to the UE reader or gNB, it can reduce the gain of the reflection amplifier. If the A-IoT device is far from the UE reader or gNB, it can increase the gain of the reflection amplifier. This can be achieved by using a feedback loop that adjusts the gain based on the error between the estimated distance and a target distance.

### Adaptive Power Control

To implement the strategy based on the given protocol, the UE reader or gNB can adaptively adjust the power of the incident signal. This can be done in the following ways:

1. Signal Quality-Based Control: The UE reader or gNB can estimate the quality of the received signal from the A-IoT device. If the signal quality is good, the UE reader or gNB can reduce the power of the incident signal. If the signal quality is poor, the UE reader or gNB can increase the power of the incident signal. This can be achieved by using a feedback loop that adjusts the incident signal power based on the error between the estimated signal quality and a target signal quality.

2. Distance-Based Control: The UE reader or gNB can estimate the distance to the A-IoT device. If the A-IoT device is close to the UE reader or gNB, it can reduce the power of the incident signal. If the A-IoT device is far from the UE reader or gNB, it can increase the power of the incident signal. This can be achieved by using a feedback loop that adjusts the incident signal power based on the error between the estimated distance and a target distance.

### Power Ramping

To implement the strategy based on the given protocol, the UE reader or gNB can start transmitting the command at a low power level and gradually increase the power until the A-IoT device responds. Here's how this can be done:

1. Initial Transmission: The UE reader or gNB starts by transmitting the command at a low power level. This initial power level should be high enough to reach the closest A-IoT devices but low enough to minimize the potential for interference or receiver overload.

2. Power Increment: If the A-IoT device does not respond, the UE reader or gNB increases the power of the incident signal by a small increment. The size of this increment should be chosen based on the specific characteristics of the UE reader or gNB and the A-IoT device, as well as the environment in which they are deployed.

3. Repeat Until Response: The UE reader or gNB repeats the process of increasing the power and waiting for a response from the A-IoT device until it receives a response. Once the A-IoT device responds, the UE reader or gNB stops increasing the power.

In the given protocol, the UE reader or gNB initiates the communication by broadcasting a command to the A-IoT device. The A-IoT device then responds with a random sequence in a chosen time duration. The UE reader or gNB acknowledges this transmission, and the A-IoT device replies with a unique identifier when there is a match. By using power ramping, the UE reader or gNB can ensure that the power of the incident signal is just high enough to reach the A-IoT device, thus minimizing the potential for interference or receiver overload.

In a first aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command to adjust the power of the incident signal, if the UE is in a state of initiating communication with a backscatter device,
Determine the power of the incident signal to be transmitted to the backscatter device, if the estimated distance to the backscatter device or the quality of the received signal from the backscatter device is known,
Perform adjustment of the power of the incident signal based on the determined power, if the UE is in a state of broadcasting the command to the backscatter device,
Transmit, to the BS, an acknowledgment of the transmission, if the backscatter device responds with a unique identifier.

In a second aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command to control the gain of the reflection amplifier, if the UE is in a state of communicating with a backscatter device,
Determine the gain of the reflection amplifier on the backscatter device, if the quality of the received signal from the backscatter device or the estimated distance to the backscatter device is known,
Perform adjustment of the gain of the reflection amplifier based on the determined gain, if the backscatter device is in a state of amplifying the reflected signal,
Transmit, to the BS, a modulated reflected signal, if the backscatter device is in a state of reflecting the incident signal.

### UL Power Control on the Random Sequence

To support UL power control between a UE/gNB reader and an Ambient Internet of Things (A-IoT) device, we can make minimal changes to the existing PRACH power control mechanism. Here's a revised overview of the PRACH power control mechanism with the necessary modifications:

1. Command Transmission: The UE/gNB reader initiates the process by transmitting a command to the A-IoT device. This command outlines essential communication parameters such as the tag rate, the tag data encoding method, and the total number of available time durations. This is analogous to the SSB and SIB1 reception in the original PRACH power control mechanism.

2. Initial Reflection Coefficient and Amplifier Gain Calculation: Upon receiving the command, the A-IoT device calculates the initial reflection coefficient and the gain of its reflection amplifier. This calculation is done using a formula similar to the one used in the original PRACH power control mechanism, but adapted for the reflection coefficient and amplifier gain:

$$REFLECTION\_COEFFICIENT = initialReflectionCoefficient + DELTA\_REFLECTION + ( REFLECTION\_RAMPING \_COUNTER - 1 ) * reflectionRampingStep$$

$$AMPLIFIER\_GAIN = initialAmplifierGain + DELTA\_GAIN + ( GAIN\_RAMPING \_COUNTER - 1 ) * gainRampingStep$$

3. Random Sequence Generation and Signal Reflection: The A-IoT device generates a random sequence based on its unique identifier and the command parameters. This sequence is then used to modulate the reflected signal, which is sent back to the UE/gNB reader in a chosen time duration.

4. Reflection Coefficient and Amplifier Gain Ramping: If the UE/gNB reader does not respond to the reflected signal (i.e., the A-IoT device does not receive an acknowledgment within the specified time window), the A-IoT device increases its reflection coefficient and amplifier gain by certain step sizes (reflectionRampingStep and gainRampingStep respectively) and uses the new values if it receives another command from the gNB or the UE reader. This process is repeated until the UE/gNB reader responds or the maximum number of transmissions is reached.

5. Acknowledgment Reception: If the UE/gNB reader detects the reflected signal, it sends an acknowledgment to the A-IoT device. This acknowledgment includes the decoded random sequence and is sent within a predetermined duration.

6. Reflection Coefficient and Amplifier Gain Adjustment: Based on the acknowledgment from the UE/gNB reader, the A-IoT device adjusts its reflection coefficient and amplifier gain. This adjustment is done to ensure that the UE/gNB reader can detect the reflected signal while also minimizing interference with other devices.

7. Unique Identifier Transmission: Once the A-IoT device has adjusted its reflection coefficient and amplifier gain and matched the decoded sequence in the acknowledgment with the chosen sequence, it reflects a signal that encodes a unique identifier.

The following terms are part of the power control mechanism of the A-IoT device. They allow the A-IoT device to adaptively adjust its reflection coefficient and amplifier gain to ensure that its reflected signal can be detected by the UE/gNB reader, while also minimizing interference with other devices.

REFLECTION_COEFFICIENT: This is a measure of how much of an incident signal is reflected by the A-IoT device. A higher reflection coefficient means more of the signal is reflected back towards the source (UE/gNB reader).

initialReflectionCoefficient: This is the starting value of the reflection coefficient before any adjustments are made. It's the base value from which the A-IoT device begins its power ramping process.

DELTA_REFLECTION: This is the change in the reflection coefficient from its initial value. It represents the adjustment made to the initial reflection coefficient based on the command received from the UE/gNB reader.

REFLECTION_RAMPING_COUNTER: This is a counter that keeps track of the number of times the A-IoT device has increased its reflection coefficient due to not receiving a response from the UE/gNB reader.

reflectionRampingStep: This is the step size by which the reflection coefficient is increased each time the A-IoT device does not receive a response from the UE/gNB reader. It determines the rate at which the reflection coefficient is ramped up.

AMPLIFIER_GAIN: This is a measure of how much the A-IoT device amplifies the reflected signal. A higher amplifier gain means the reflected signal is stronger.

initialAmplifierGain: This is the starting value of the amplifier gain before any adjustments are made. It's the base value from which the A-IoT device begins its power ramping process.

DELTA_GAIN: This is the change in the amplifier gain from its initial value. It represents the adjustment made to the initial amplifier gain based on the command received from the UE/gNB reader.

GAIN_RAMPING_COUNTER: This is a counter that keeps track of the number of times the A-IoT device has increased its amplifier gain due to not receiving a response from the UE/gNB reader.

gainRampingStep: This is the step size by which the amplifier gain is increased each time the A-IoT device does not receive a response from the UE/gNB reader. It determines the rate at which the amplifier gain is ramped up.

This revised mechanism allows the A-IoT device to adapt its reflection coefficient and amplifier gain based on the command from the UE/gNB reader and the acknowledgment from the UE/gNB reader, thereby ensuring that the reflected signal can be detected by the UE/gNB reader while also minimizing interference. This approach requires minimal changes to the existing PRACH power control mechanism and can effectively support UL power control between a UE/gNB reader and an A-IoT device.

The A-IoT device can determine whether to reset the power ramping process based on the acknowledgment it receives from the UE/gNB reader.

When the A-IoT device receives an acknowledgment from the UE/gNB reader, it means that the reflected signal has been successfully detected. In this case, the A-IoT device can reset the reflection coefficient and amplifier gain to their initial values for the next transmission.

If the A-IoT device does not receive an acknowledgment within a specified time window, it means that the reflected signal has not been detected. In this case, the A-IoT device increases its reflection coefficient and amplifier gain for the next command it receives from the gNB or the UE reader. This process is repeated until the UE/gNB reader responds or the maximum number of transmissions is reached.

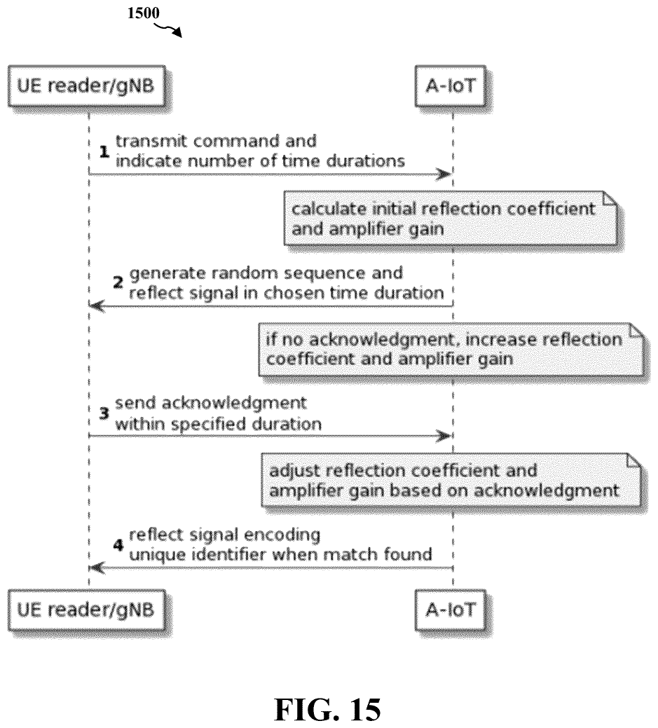

FIG. 15 is a sequence diagram 1500 for the UE reader/gNB and A-IoT device interaction. In this sequence diagram:

The UE reader/gNB (r) initiates the process by transmitting a command to the A-IoT device (a) and indicating the number of time durations.

The A-IoT device calculates the initial reflection coefficient and amplifier gain.

The A-IoT device generates a random sequence and reflects the signal in a chosen time duration.

If the A-IoT device does not receive an acknowledgment, it increases its reflection coefficient and amplifier gain.

The UE reader/gNB sends an acknowledgment within a specified duration.

The A-IoT device adjusts its reflection coefficient and amplifier gain based on the acknowledgment.

If the A-IoT device finds a match, it reflects a signal encoding a unique identifier.

In a first aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command outlining essential communication parameters such as the tag rate, the tag data encoding method, and the total number of available time durations, if the UE is in the process of UL power control with an Ambient Internet of Things (A-IoT) device.

Determine the initial reflection coefficient and amplifier gain based on the received command, if the UE does not receive an acknowledgment from the BS within a specified time window.

Perform the generation of a random sequence based on its unique identifier and the command parameters, and use this sequence to modulate the reflected signal, if the UE is in the process of signal reflection to the BS.

Transmit, to the BS, a signal that encodes a unique identifier, if the UE has adjusted its reflection coefficient and amplifier gain and matched the decoded sequence in the acknowledgment with the chosen sequence.

In a second aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), an acknowledgment that includes the decoded random sequence and is sent within a predetermined duration, if the BS detects the reflected signal from the UE.
Determine whether to reset the power ramping process based on the acknowledgment it receives from the BS, if the reflected signal has been successfully detected.
Perform an increase in its reflection coefficient and amplifier gain by certain step sizes and use the new values if it receives another command from the BS, if the UE does not receive an acknowledgment within the specified time window.
Transmit, to the BS, a reflected signal in a chosen time duration, if the UE generates a random sequence based on its unique identifier and the command parameters.

### UL Power Control on the EPC

A-IoT devices, being passive and utilizing backscattering for communication, require a unique approach to uplink power control. This section outlines how the NR UL power control for MSG3 can be adapted to support A-IoT devices, in the context of the specified protocol.

1. Initial Power Calculation for A-IoT: Unlike active devices, A-IoT devices do not transmit power. They modulate the reflected signal from the UE reader/gNB. The strength of this reflected signal is dependent on the incident power from the UE reader/gNB and the reflection coefficient of the A-IoT device. The UE reader/gNB can adjust the incident power based on factors such as path loss, configured power control parameters, and the reflection characteristics of the A-IoT device. When the UE reader/gNB broadcasts a command and indicates the number of time durations, the A-IoT device decodes the command and chooses a random time duration.

2. Power Control Adjustment for A-IoT: A-IoT devices modulate the reflection coefficient or reflection amplifier gain to alter the strength of the backscattered signal, rather than adjusting uplink transmit power. The UE reader/gNB modifies its transmit power based on power control commands to ensure the backscattered signal from the A-IoT device is detectable. These power control commands can include parameters like the desired backscattered signal strength, the modulation scheme, and the data encoding method. When the A-IoT device responds with a random sequence using FM0 modulation in the chosen time duration, the UE reader/gNB decodes the random sequence and sends an acknowledgment.

3. Power Ramping for A-IoT: Power ramping is not applicable to A-IoT devices as they do not actively transmit power. However, if the UE reader/gNB fails to receive an acknowledgment, it can increase its transmit power to enhance the incident power on the A-IoT device, thereby boosting the strength of the backscattered signal. The A-IoT device can also adjust its reflection amplifier gain to ensure the backscattered signal strength meets the requirements.

4. Power Capping for A-IoT: A-IoT devices do not actively transmit power, making power capping inapplicable. However, the UE reader/gNB should still cap its transmit power to prevent excessive interference. The maximum transmit power can be determined based on the A-IoT device's reflection characteristics, the interference constraints, and the regulatory limits.

5. Power Control for A-IoT: When the A-IoT device receives an acknowledgment within a specified duration, it matches the decoded sequence in the acknowledgment with the chosen sequence. If there is a match, the A-IoT device replies with a unique identifier. During this process, the A-IoT device adjusts its reflection coefficient or reflection amplifier gain based on the power control commands received from the UE reader/gNB.

Here's a simplified formula for the A-IoT power control:

$$P\_reflection = min ( P\_max , P\_O \_REFLECTION + α * ( PL ) + Δ TF + f ( i ) )$$

Where:
P_reflection is the reflection power for A-IoT.
P_max is the maximum reflection power.
P_O_REFLECTION is the configured nominal reflection power.
α is the path loss compensation factor.
PL is the path loss.
ΔTF is the power adjustment due to the selected transport format.
f(i) is the power control adjustment function, which depends on the power control commands received from the UE reader/gNB.

By considering the passive nature of A-IoT devices and their use of backscattering for communication, the power control process can be adapted to ensure efficient communication while minimizing interference.

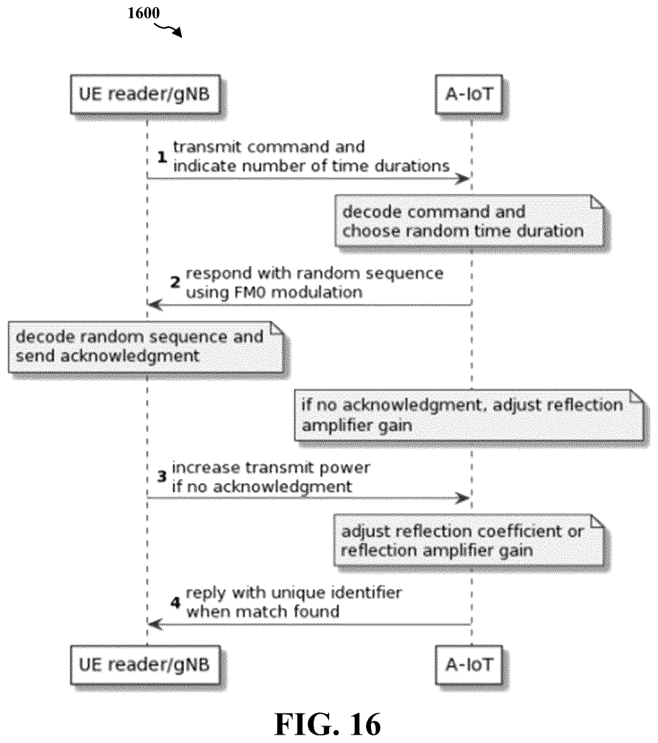

FIG. 16 is another sequence diagram 1600 for the UE reader/gNB and A-IoT device interaction. In this sequence diagram:

The UE reader/gNB (u) initiates the process by transmitting a command to the A-IoT device (a) and indicating the number of time durations.

The A-IoT device decodes the command and chooses a random time duration.

The A-IoT device responds with a random sequence using FM0 modulation.

The UE reader/gNB decodes the random sequence and sends an acknowledgment.

If the A-IoT device does not receive an acknowledgment, it adjusts its reflection amplifier gain.

The UE reader/gNB increases its transmit power if it does not receive an acknowledgment.

The A-IoT device adjusts its reflection coefficient or reflection amplifier gain based on the power control commands received from the UE reader/gNB.

If the A-IoT device finds a match, it replies with a unique identifier.

In a first aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), a command and the number of time durations, if the UE is an A-IoT device utilizing backscattering for communication.

Determine a random time duration from the received number of time durations, if the UE is an A-IoT device and does not transmit power actively.

Perform modulation of the reflection coefficient or reflection amplifier gain to alter the strength of the backscattered signal, if the UE is an A-IoT device and receives power control commands from the BS.

Transmit, to the BS, a unique identifier when a match is found between the decoded sequence in the acknowledgment and the chosen sequence, if the UE is an A-IoT device and receives an acknowledgment within a specified duration.

In a second aspect, a user equipment (UE), including:
one or more non-transitory computer-readable media having computer-executable instructions embodied thereon, and at least one processor coupled to the one or more non-transitory computer-readable media and configured to execute the computer-executable instructions to:
Receive from a base station (BS), power control commands to ensure the backscattered signal from the UE is detectable, if the UE is an A-IoT device and modulates the reflection coefficient or reflection amplifier gain.

Determine the reflection power for the A-IoT device using the formula P_reflection=min(P_max, P_O_REFLECTION+α*(PL)+ΔTF+f(i)), if the UE is an A-IoT device and does not transmit power actively.

Perform adjustment of its reflection amplifier gain to ensure the backscattered signal strength meets the requirements, if the UE is an A-IoT device and does not receive an acknowledgment from the BS.

Transmit, to the BS, a response with a random sequence using FM0 modulation in the chosen time duration, if the UE is an A-IoT device and decodes the command from the BS.

In a third aspect, a user equipment (UE), including:
one or more non-transitory computer-readable media having computer-executable instructions embodied thereon, and at least one processor coupled to the one or more non-transitory computer-readable media and configured to execute the computer-executable instructions to:

Receive from a base station (BS), power control commands to ensure the backscattered signal from the UE is detectable, if the UE is an A-IoT device and modulates the reflection coefficient or reflection amplifier gain.

Determine the reflection power for the A-IoT device using the formula P_reflection=min(P_max, P_O_REFLECTION+α*(PL)+ΔTF+f(i)), if the UE is an A-IoT device and does not transmit power actively.

Perform adjustment of its reflection amplifier gain to ensure the backscattered signal strength meets the requirements, if the UE is an A-IoT device and does not receive an acknowledgment from the BS.

Transmit, to the BS, a response with a random sequence using FM0 modulation in the chosen time duration, if the UE is an A-IoT device and decodes the command from the BS.

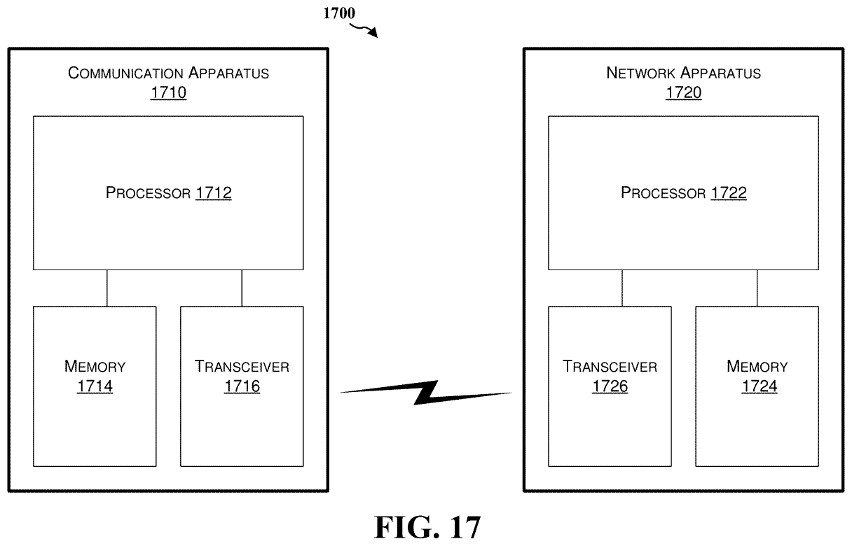

FIG. 17 illustrates an example communication system 1700 having an example communication apparatus 1710 and an example network apparatus 1720 in accordance with an implementation of the present disclosure. Each of communication apparatus 1710 and network apparatus 1720 may perform various functions to implement schemes, techniques, processes and methods described herein pertaining to using on-demand reference signal for network energy saving with respect to user equipment and network apparatus in mobile communications, including scenarios/schemes described above as well as processes 1800 and 1900 described below.

Communication apparatus 1710 may be a part of an electronic apparatus, which may be a UE such as a portable or mobile apparatus, a wearable apparatus, a wireless communication apparatus or a computing apparatus. For instance, communication apparatus 1710 may be implemented in a smartphone, a smartwatch, a personal digital assistant, a digital camera, or a computing equipment such as a tablet computer, a laptop computer or a notebook computer. Communication apparatus 1710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1710 may be implemented in a smart thermostat, a smart fridge, a smart door lock, a wireless speaker or a home control center. Alternatively, communication apparatus 1710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1710 may include at least some of those components shown in FIG. 17 such as a processor 1712, for example. Communication apparatus 1710 may further include one or more other components not pertinent to the proposed scheme of the present disclosure (e.g., internal power supply, display device and/or user interface device), and, thus, such component(s) of communication apparatus 1710 are neither shown in FIG. 17 nor described below in the interest of simplicity and brevity.

Network apparatus 1720 may be a part of a network apparatus, which may be a network node such as a satellite, a base station, a small cell, a router or a gateway. For instance, network apparatus 1720 may be implemented in an eNodeB in an LTE network, in a gNB in a 5G/NR, IoT, NB-IoT or IIoT network or in a satellite or base station in a 6G network. Alternatively, network apparatus 1720 may be implemented in the form of one or more IC chips such as, for example and without limitation, one or more single-core processors, one or more multi-core processors, or one or more RISC or CISC processors. Network apparatus 1720 may include at least some of those components shown in FIG. 17 such as a processor 1722, for example. Network apparatus 1720 may further include one or more other components not pertinent to the proposed scheme of the present disclosure (e.g., internal power supply, display device and/or user interface device), and, thus, such component(s) of network apparatus 1720 are neither shown in FIG. 17 nor described below in the interest of simplicity and brevity.

In one aspect, each of processor 1712 and processor 1722 may be implemented in the form of one or more single-core processors, one or more multi-core processors, or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including autonomous reliability enhancements in a device (e.g., as represented by communication apparatus 1710) and a network (e.g., as represented by network apparatus 1720) in accordance with various implementations of the present disclosure.

In some implementations, communication apparatus 1710 may also include a transceiver 1716 coupled to processor 1712 and capable of wirelessly transmitting and receiving data. In some implementations, communication apparatus 1710 may further include a memory 1714 coupled to processor 1712 and capable of being accessed by processor 1712 and storing data therein. In some implementations, network apparatus 1720 may also include a transceiver 1726 coupled to processor 1722 and capable of wirelessly transmitting and receiving data. In some implementations, network apparatus 1720 may further include a memory 1724 coupled to processor 1722 and capable of being accessed by processor 1722 and storing data therein. Accordingly, communication apparatus 1710 and network apparatus 1720 may wirelessly communicate with each other via transceiver 1716 and transceiver 1726, respectively. To aid better understanding, the following description of the operations, functionalities and capabilities of each of communication apparatus 1710 and network apparatus 1720 is provided in the context of a mobile communication environment in which communication apparatus 1710 is implemented in or as a communication apparatus or a UE and network apparatus 1720 is implemented in or as a network node of a communication network.

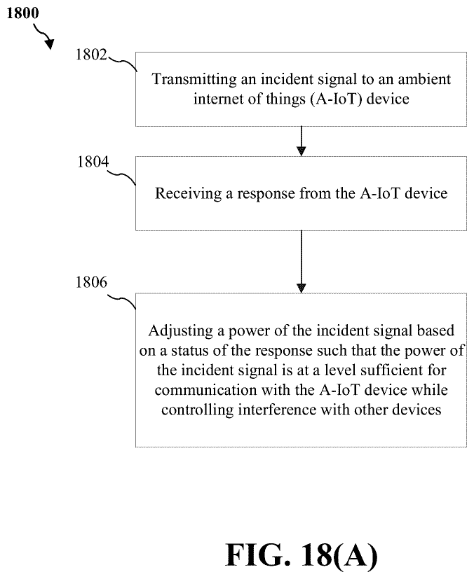

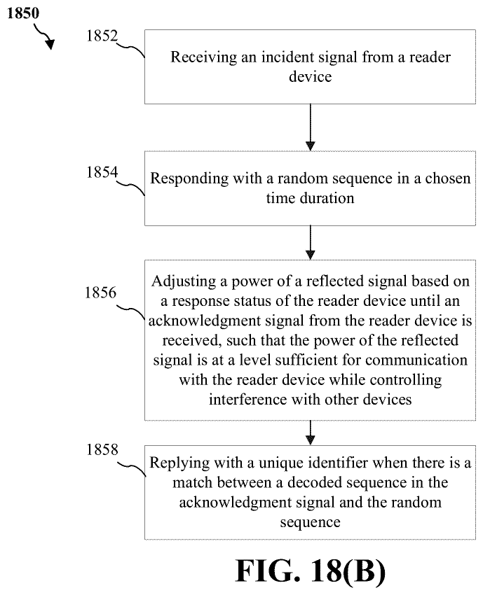

FIG. 18(A) is a flow chart 1800 of a process for UL power control regarding a reader device and an A-IoT device. This process involves interactions between a gNB, a UE (e.g., the UE 904), and an ambient internet of things (A-IoT) device (e.g., the A-IoT device 906).

At block 1802, a reader device may transmit an incident signal to an ambient internet of things (A-IoT) device. The reader device may be the UE 904 or the gNB.

Then, at block 1804, the reader device, e.g., the UE 904, may receive a response from the A-IoT device.

Finally, at block 1806, the reader device may adjust a power of the incident signal based on a status of the response such that the power of the incident signal is at a level sufficient for communication with the A-IoT device while controlling interference with other devices.

In some embodiments, when the reader device is the UE 904, the method may further include: receiving a command from the gNB to perform the transmitting.

In some embodiments, transmitting the incident signal may include initially transmitting the incident signal at a fixed power level. In some embodiments, adjusting the power of the incident signal may include adjusting the power based on at least one of a path loss, a set of power control parameters, and reflection characteristics of the A-IoT device. The set of power control parameters, for example, may include at least one of a desired reflection signal strength, a modulation scheme, and a data encoding method.

In some embodiments, adjusting the power of the incident signal may include adjusting the power based on at least one of an estimated distance to the A-IoT device and a quality of a reflected signal received from the A-IoT device. In some embodiments, adjusting the power of the incident signal may also include: starting to transmit the incident signal at an initial power level; and gradually increasing the power of the incident signal until a response is received from the A-IoT device. For example, gradually increasing the power of the incident signal may include increasing the power by increments, and a size of each increment is selected based on at least one of characteristics of the reader device, characteristics of the A-IoT device, and an environment in which the reader device and the A-IoT device are deployed.

In some embodiments, transmitting the incident signal may include transmitting, during an initiation process, an incident signal including a parameter set including at least one of a tag rate, a tag data encoding method, and a total number of available time durations.

In some embodiments, the process may further include: transmitting an acknowledgment signal to the A-IoT device when a reflection signal from the A-IoT device is detected, the acknowledgment signal including a decoded random sequence and being sent within a predetermined duration.

In some embodiments, adjusting the power of the incident signal may include determining a maximum power for the incident signal based on at least one of reflection characteristics of the A-IoT device, interference constraints, and regulatory limits.

FIG. 18(B) is a flow chart 1850 of another process for UL power control regarding a reader device and an A-IoT device.

At block 1852, an A-IoT device, e.g., the A-IoT device 906, may receive an incident signal from a reader device. The reader device, may be a UE, e.g., the UE 904, or a gNB.

Then, at block 1854, the A-IoT device 906 may respond with a random sequence in a chosen time duration.

Subsequently, at block 1856, the A-IoT device 906 may adjust a power of a reflected signal based on a response status of the reader device until an acknowledgment signal from the reader device is received, such that the power of the reflected signal is at a level sufficient for communication with the reader device while controlling interference with other devices.

Finally, at block 1858, the A-IoT device 906 may reply with a unique identifier when there is a match between a decoded sequence in the acknowledgment signal and the random sequence.

In some embodiments, adjusting the power of the reflected signal may include changing at least one of a reflection coefficient of the A-IoT device and a reflection amplifier gain of the A-IoT device. For example, changing the reflection coefficient may include changing an antenna impedance of the A-IoT device.

In some embodiments, adjusting the reflection coefficient or the reflection amplifier gain may be based on a power control command received from the reader device.

In some embodiments, the process may further include: when the acknowledgment signal is not received within a specified time window, increasing the reflection coefficient or the reflection amplifier gain by a step size, and repeating until a response from the reader device is received or a maximum number of transmissions is reached.

In some embodiments, the random sequence may be modulated using FM0 modulation.

In some embodiments, adjusting the reflection amplifier gain may include at least one of: estimating a signal quality of a signal received from the reader device and using a feedback loop that adjusts the reflection amplifier gain based on an error between the estimated signal quality and a target signal quality; and estimating a distance to the reader device and using a feedback loop that adjusts the reflection amplifier gain based on an error between the estimated distance and a target distance.

In some embodiments, the process may further include: when the acknowledgment signal is received, resetting the reflection coefficient and the reflection amplifier gain to initial values for a next transmission.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a reader device, comprising:
transmitting an incident signal to an ambient internet of things (A-IoT) device;
receiving a response from the A-IoT device; and
adjusting a power of the incident signal based on a status of the response.

2. The method of claim 1, wherein the reader device comprises a user equipment (UE) or a gNodeB (gNB).

3. The method of claim 2, wherein when the reader device is the UE, the method further comprises:
receiving a command from the gNB to perform the transmitting.

4. The method of claim 1, wherein transmitting the incident signal comprises initially transmitting the incident signal at a fixed power level.

5. The method of claim 1, wherein adjusting the power of the incident signal comprises adjusting the power based on at least one of a path loss, a set of power control parameters, and reflection characteristics of the A-IoT device, wherein the set of power control parameters comprises at least one of a desired reflection signal strength, a modulation scheme, and a data encoding method.

6. The method of claim 1, wherein adjusting the power of the incident signal comprises adjusting the power based on at least one of an estimated distance to the A-IoT device and a quality of a reflected signal received from the A-IoT device.

7. The method of claim 1, wherein adjusting the power of the incident signal comprises:
starting to transmit the incident signal at an initial power level; and
gradually increasing the power of the incident signal until a response is received from the A-IoT device.

8. The method of claim 7, wherein gradually increasing the power of the incident signal comprises increasing the power by increments, and wherein a size of each increment is selected based on at least one of characteristics of the reader device, characteristics of the A-IoT device, and an environment in which the reader device and the A-IoT device are deployed.

9. The method of claim 1, wherein transmitting the incident signal comprises transmitting, during an initiation process, an incident signal including a parameter set comprising at least one of a tag rate, a tag data encoding method, and a total number of available time durations.

10. The method of claim 1, further comprising:
transmitting an acknowledgment signal to the A-IoT device when a reflection signal from the A-IoT device is detected, the acknowledgment signal including a decoded random sequence and being sent within a predetermined duration.

11. The method of claim 1, wherein adjusting the power of the incident signal comprises determining a maximum power for the incident signal based on at least one of reflection characteristics of the A-IoT device, interference constraints, and regulatory limits.

12. A method of wireless communication of an ambient internet of things (A-IoT) device, comprising:
receiving an incident signal from a reader device;
responding with a random sequence in a chosen time duration;
adjusting a power of a reflected signal based on a response status of the reader device until an acknowledgment signal from the reader device is received; and
replying with a unique identifier when there is a match between a decoded sequence in the acknowledgment signal and the random sequence.

13. The method of claim 12, wherein adjusting the power of the reflected signal comprises changing at least one of a reflection coefficient of the A-IoT device and a reflection amplifier gain of the A-IoT device.

14. The method of claim 13, wherein changing the reflection coefficient comprises changing an antenna impedance of the A-IoT device.

15. The method of claim 13, wherein adjusting the reflection coefficient or the reflection amplifier gain is based on a power control command received from the reader device.

16. The method of claim 13, further comprising:
when the acknowledgment signal is not received within a specified time window, increasing the reflection coefficient or the reflection amplifier gain by a step size, and repeating until a response from the reader device is received or a maximum number of transmissions is reached.

17. The method of claim 12, wherein the random sequence is modulated using FM0 modulation.

18. The method of claim 13, wherein adjusting the reflection amplifier gain comprises at least one of:
estimating a signal quality of a signal received from the reader device and using a feedback loop that adjusts the reflection amplifier gain based on an error between the estimated signal quality and a target signal quality; and
estimating a distance to the reader device and using a feedback loop that adjusts the reflection amplifier gain based on an error between the estimated distance and a target distance.

19. The method of claim 13, further comprising:
when the acknowledgment signal is received, resetting the reflection coefficient and the reflection amplifier gain to initial values for a next transmission.

20. An apparatus for wireless communication, the apparatus being a user equipment (UE), comprising:
a memory; and
at least one processor coupled to the memory and configured to:
transmit an incident signal to an ambient internet of things (A-IoT) device;
receive a response from the A-IoT device; and
adjust a power of the incident signal based on a status of the response.
